(19) United States
(12) Patent Application Publication
(10) Pub. No.: US 2013/0335986 A1
(43) Pub. Date: Dec. 19, 2013

(54) ILLUMINATED SHIFTER LINKAGE ASSEMBLY HAVING THREE-DIMENSIONAL EFFECTS

(71) Applicant: CHARLES BERRY, Holiday, FL (US)

(72) Inventor: CHARLES BERRY, Holiday, FL (US)

(21) Appl. No.: 13/909,805

(22) Filed: Jun. 4, 2013

Related U.S. Application Data
(60) Provisional application No. 61/655,662, filed on Jun. 5, 2012.

(51) Int. Cl. B62J 6/00

(52) U.S. Cl. CPC B62J 6/00
USPC 362/473

(57) ABSTRACT

In certain aspects, the present invention relates to an apparatus and methods including a shift linker assembly for a motorcycle. The assembly includes a shaft comprising a first and second end and a wall therebetween that defines an interior space and at least one opening. A translucent member is receivable within the at least one opening of the wall comprising a first translucent surface and a second reflective surface, which is visible through the translucent surface and through at least one opening in the shaft. At least one light source is disposed within the interior space of the shaft.

### CROSS REFERENCES TO RELATED APPLICATIONS

The present application claims priority to U.S. Provisional Application Ser. No. 61/655,662, filed Jun. 5, 2012, the contents of which are incorporated herein by reference in its entirety.

### FIELD OF THE INVENTION

The present invention relates, in part, to a shifter linkage assembly for use with a motorcycle, which is illuminatable and customizable to provide three-dimensional effects.

### BACKGROUND OF THE INVENTION

Since the creation of the bicycle and motorcycle, riders have searched for ways to improve safety, while simultaneously providing unique customization that has aesthetic appeal. Illumination technologies provide one effective mechanism of achieving both. Riders, for example, have incorporated externally mountable devices to some portion of the bike that provides illumination to the ground and/or surrounding area. Light fixtures that are mountable to the handle bars or frame of a bicycle (such as those described in U.S. Pat. Nos. 4,337,503 and 4,819,135) provide just a few examples.

Illumination technologies have also been incorporated within existing (or replacement) parts of the bicycle or motorcycle. U.S. Pat. No. 3,355,581, for example, incorporates illumination technology into a motorcycle tail pipe. U.S. Pat. No. 4,797,791 provides illumination using a motorcycle foot peg. U.S. Pat. No. 5,634,706 provides illumination to a motorcycle gas tank, and U.S. Pat. No. 7,018,080 provides illuminated spark plug connectors.

U.S. Pat. No. 6,761,240 similarly provides an illuminated shift linkage apparatus, which links the shifter pedal with the transmission of a motorcycle. In certain embodiments, it provides “a substantially rigid, longitudinally extending shaft having a hollowed portion defining an interior shaft space, and a light-emitting source disposed within the interior shaft space. Portions of the shaft wall have apertures or otherwise decorative cut regions provided therein for enabling transmission of the emitted light therethrough.”

Even in view of the foregoing, improved or alternative embodiments of such illuminating means are desirable in the art.

### SUMMARY OF THE INVENTION

In certain non-limiting embodiments, the present invention relates to a shift linker assembly for a motorcycle including a shaft, a translucent member, and at least one light source. The shaft includes a first end and second end and a wall therebetween defining an interior cavity and at least one opening. The translucent member is receivable within the at least one opening of the wall and is manufactured from a translucent material having at least one reflective surface and at least one translucent surface, where the reflective surface is visible through the translucent surface and through at least one opening of the shaft. The least one light source is disposed within the interior space of the shaft adjacent to or near the reflective surface of the first member. In certain embodiments, it provides a back light to the translucent member.

In further aspects of the foregoing, the shift linker assembly includes at least two openings between the first and second ends of the shaft. The first opening receives the translucent member such that the translucent surface and the reflective surface are visible through the second opening. The light source is then disposed between the translucent member and the first opening. In such embodiments, the shift linkage further includes a backing adapted to lockingly engage the shaft wall and maintain the translucent member and light source between the backing and the second opening.

In even further embodiments of the foregoing, the translucent member is formed to provide a lip around its periphery and an interior portion extending from the lip. When provided within the shaft, the interior portion is sized to fit within the at least one opening of the shaft so as to extend from the interior side of the shaft to the exterior side. The lip has a width and length that may be greater than the opening. To this end, the translucent member extends into the at least one opening but is prevented from passing all the way through by the lip.

In any of the foregoing embodiments, the reflective surface of the translucent member is engravable or etchable such that the engraving or etching is visible through the translucent surface of the translucent member. When the light source is turned on, the light passing through the translucent member and/or reflecting from the reflective surface gives the engraving or etching a three-dimensional effect.

In alternative embodiments, the present invention relates to methods for providing illumination to a shift linker assembly of a motorcycle by (1) providing a shift linker assembly in accordance with any of the foregoing embodiments and (2) engraving or etching the reflective surface of the translucent member such that the engraving or etching is visible through the translucent surface of the translucent member. Again, light from the light source passes through the translucent member or is reflected off of the reflective surface and passes through the translucent member. Reflection and/or refraction of the light causes the etched or engraved image on the reflective surface to appear three-dimensional. Accordingly, the apparatus and methods of the present invention provide a customizable shift linker assembly that provides safety to the rider of a motorcycle while also providing aesthetic appeal.

One of skill in the art will appreciate that the foregoing is not limiting to the invention. Additional modifications, changes, or advantages will be readily apparent to the skill artisan based on the disclosure provided herein.

### BRIEF DESCRIPTION OF THE DRAWINGS

FIG. 1 provides a top-view perspective of one embodiment of the shift linker assembly, illustrating one opening in the shaft component and the translucent member being visible therethrough.

FIG. 2 provides a side-view perspective of one embodiment of the shaft linker assembly, having a cut-away along line A-A of FIG. 1 and illustrating a first and a second opening and the translucent member contained therein.

FIG. 3 provides an end-view perspective of one embodiment of the shaft linker assembly.

FIG. 4 provides an end-view, cut-away, perspective along line B-B of FIG. 1.

FIGS. 5A-C provide top, end, and side views, respectively, of one embodiment of the translucent member of the present invention.

FIGS. 6A-C provide top, side, and end view perspectives, respectively, of one embodiment of a backing member of the present invention.

### DETAILED DESCRIPTION OF THE INVENTION

In certain non-limiting aspects, the present invention relates to a customizable shift linkage assembly for a motorcycle that, when illuminated from a light source contained therein, provides a three-dimensional viewing effect to an observer. As discussed in greater detail, the three-dimensional effect is provided from a translucent member having a reflective finish on one side that is backlit with white or colored light. The reflective surface may be customized by engraving or etching it with letters, numbers, symbols, or any artistic expression, which may be unique or personal to the individual. The following embodiments describe certain features of the shifter linkage assembly, but are not necessarily limiting to the invention. One of skill in the art will readily appreciate that modifications of the following may be made to yield the same or similar results. Such modifications are inclusive within the present invention.

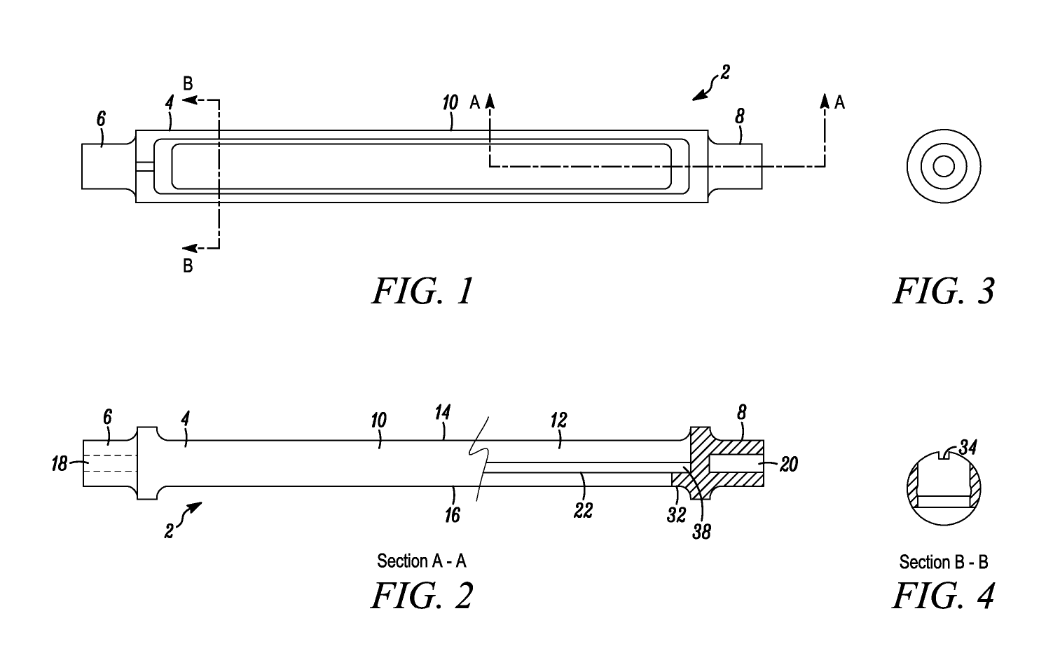

Referring to FIGS. 1 and 2, one embodiment of a shift linker assembly 2 is illustrated. More specifically, it is illustrated as including a shaft 4 having a first end 6 and second end 8. A wall 10 between the first end 6 and the second end 8 defines an interior cavity 12 and at least one opening. In certain non-limiting embodiments of the invention, the wall 10 defines a first opening 14 and a second opening 16.

As illustrated in the cut-away portion of FIG. 2 (labeled section A-A), in certain embodiments, the first opening 14 extends along the length of the shaft 10 from its first end 6 to its second end 8 and is part of a flat portion of shaft 4 that is beveled in from a round extension at each end 6, 8. The second opening 16 is slightly smaller than the first 14. While it also extends substantially from the first end 6 of the shaft to the second 8, the shaft wall defines a ridge 32 around the perimeter of the second opening 16.

As discussed in greater detail below, the first opening 14 of the shaft 4 is sized to receive each of the translucent member, light source, and backing such that they may be provided, at least in part, into the cavity 12 of the shaft. The second opening is sized to receive a portion of the translucent member and display its translucent surface and reflective surface to an observer, i.e. it provides the window to which the three- dimensional effect is displayed. While the shapes of the two openings are illustrated as being rectangular and extending along the length of the shaft 4, the present invention is not limited to this design and alternative shapes, sizes, lengths, widths, and the like may be used in accordance with the present invention.

The openings 14, 16 are illustrated in FIG. 2 as being on opposing sides of the shaft 4, but the present invention is not limited to this configuration. Placement of the openings may be in any orientation or configuration such that the linker assembly 2 can operate or function in accordance with the present teachings. To this end, one of skill in the art will readily appreciate that the present invention may be adapted to contain one opening (which can function or be adaptable to both receive the components within the cavity 12 of the shaft 4 and provide the display for the three-dimensional effects) or more than two-openings and still operate in accordance with the present teachings.

In certain non-limiting aspects of the invention, the shaft 4 is provided as a round, milled, aluminum rod or casting in aluminum or stainless steel of overall length of about 9.500 inch by about 1.000 inch. The flattened area forming each opening 14, 16 is 0.750 inch high by 7.000 long after a 0.250 bevel on each end to transition down toward the center from the round surface to a flat face. The openings 14, 16 that are formed within this flat portion may be rectangularly cut or with rounded corners. Each end 6, 8 of the shaft is provided as a round surface that is additionally sloped outward and reduced in round dimension to 0.625 for 0.500 inch on each end. These dimensions and materials, however, are not necessarily limiting to the invention. One of skill in the art will readily appreciate that similar or alternative material types and dimensions may be used to achieve similar effects or advantages to the invention discussed herein.

The first end 6 and the second end 8 of the shaft 4 are adapted to receive or otherwise mate with extensions of the motorcycle shifter petal or transmission (not illustrated). Referring to FIG. 2, in one embodiment, each end of the shaft is illustrated as having separate interior spaces 18 and 20, respectively. These spaces may be provided as an extension of the cavity 12 or as discrete channels (as illustrated). Spaces 18, 20 of each shaft end are designed to receive and lockingly engage extensions of the foot petal and transmission and may be provided to fit a standard size of each extension or a custom size, dependent on the motorcycle. In certain embodiments, the interior of each space 18 and 20 are grooved, milled, or casted to form a threaded female coupling for receiving the corresponding threaded male coupling of the foot petal or transmission. For standard sizes, the spaces may be tapped to 5/16-24 thread size, 0.62 inch deep to accept threaded rod ends of 5/16″ of stainless steel or chrome, with or without Teflon inserts. One of skill in the art would readily appreciate that this coupling method is not necessarily limiting to the invention and alternative coupling mechanisms may be used. By way of non-limiting example, the first and second ends 6, 8 can be configured for snap fit , direct welding, or any other known method for providing secure coupling to the shifter pedal and gear shifting portions of the transmission.

As illustrated in FIG. 4, at least one end of the shaft contains a notch 34. In certain embodiments, the notch is at or adjacent to the first opening 14 of the shaft 4, particularly at or about one or more of the round protrusions illustrated between the shaft ends 6, 8 and the openings 14, 16. While the notch 34 may be of any size or shape, in certain aspects it is sufficiently sized to receive and frictionally maintain therewithin or therethrough an electrical wiring or a portion of a wiring harness from the light source. Such wiring may extend from the cavity 12 and notch 34 to a power source, such as the battery of the motorcycle or a separate stand-alone power source otherwise associated with the present invention (as described in greater detail below).

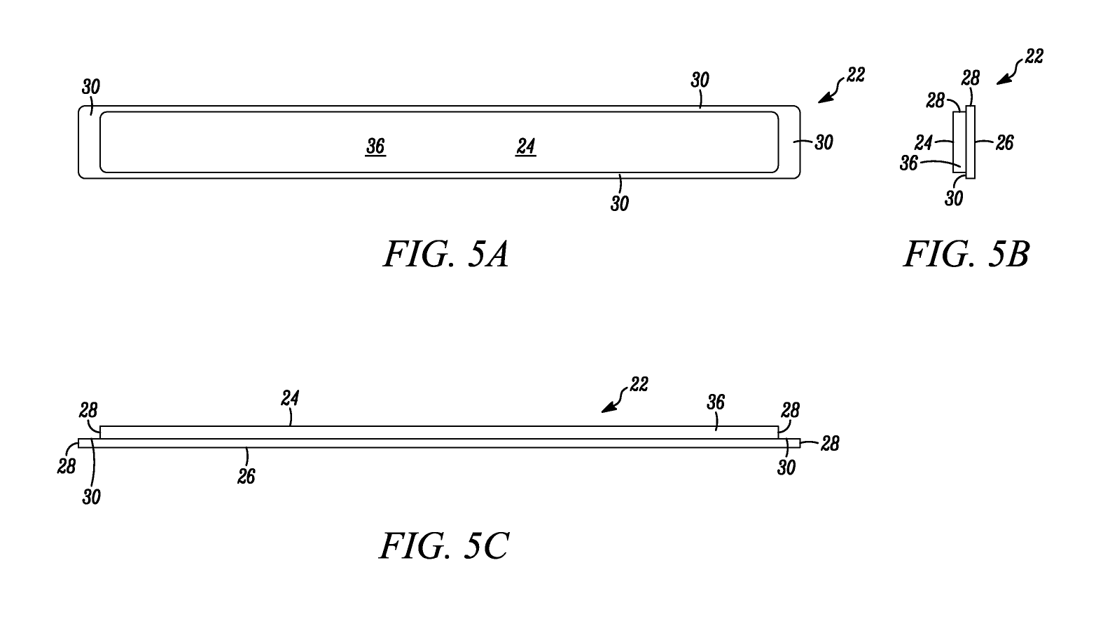

Referring to FIGS. 5A-C, receivable within the shaft cavity 12 is a translucent member 22. While the shape of the first translucent member is not necessarily limiting to the invention, the translucent member 22 is illustrated as being rectangular and including front face 24, a back face 26, and side walls 28. The sides of the translucent member 22 have a reduced width to form a lip 30 around the perimeter and resulting in a raised interior portion 36. Collectively, the lip 30 and raised portion 36 cooperate to secure the translucent member 22 within the shaft 4 (as discussed in greater detail below).

Translucent member 22 is manufactured with a translucent material. As used herein, the term “translucent material” refers to any material that allows light to pass through it. That is, in certain embodiments, light may pass through the material from one side and be visible as it passed through a different side. In certain aspects, the translucent material is light refractive. That is, it changes the phase velocity or direction of light from that of the surrounding environment. One non-limiting example of such a translucent material is, or includes, acrylic (i.e. poly(methyl methacrylate) or PMMA). One of skill in the art would readily appreciate, however, that such material is not limiting to the invention and may be substituted with any similar material, such as a glass-based or plastic-based material, having one or more of the effects described herein or otherwise usable for a purposed consistent with the present invention.

The back face 26 of the translucent member 22 is provided with a reflective finish such as, but not limited to, a mirror finish. In certain embodiments, this reflective finish is applied to the back face 26 such that the reflective portion or surface is visible through the translucent material, i.e. through the front face 24 and/or sides 28 of the member 22. The reflective finish may be provided using any standard reflective finish known in the art, particularly, though not exclusively, reflective finishes known to produce a mirror or mirror-like quality with a glass substrate. Light entering the front 24 or sides 28 of the member 22, therefore, passes through the translucent material or is reflected off of the reflective surface of the back face 26 and passes back through the translucent material.

The back face 26 of the translucent member is also adapted to be engravable or etchable such that the engraving or etching is visible through the translucent material of the member 22 from its front 24 and/or side 28 and appears within or on the reflective surface. Engraving or etching may include any standard method known in the art including, but not limited to, mechanical methods, chemical methods, laser etching or engraving, or the like, particularly, though not exclusively, engraving, etching or other methods known for use to personalize glass-, plastic, and/or mirror-based substrates.

In certain non-limiting embodiments, the overall length of the translucent member is 7.430 inch with a width of 0.740 inch with four squared or rounded corners. The engravable portion of the back face 26 has a length of 6.990 inch, vertical width 0.615 inch, thickness 0.215 inch with four rounded corners. The outside edge of the translucent member is reduced in thickness to 0.125 inch, which is included for holding the translucent member within the cavity 12. The present invention is not limited to the foregoing dimensions and may include any similar size or shape that would provide a similar effect.

As indicated above, in certain non-limiting embodiments, the translucent member 22 is receivable through the first opening 14 of the shaft 4. The second opening 16 is sized to receive the translucent member 22, particularly its raised portion 36. More specifically, the raised portion 36 of the translucent member 22 is secured within the second opening 16 such that its front face 24 extends through the opening 16 until the ridge 32 of the opening 16 contacts or is in close approximation to the lip 30 of the translucent member 22. So oriented, one viewing the second opening 16 from an exterior side of the shaft is able to see the reflective surface through the translucent member 22. Any engraving or etching in the back face 26 is similarly visible through the opening and appears on or within the reflective surface.

At least one light source is disposed within the interior space of the shaft. In one non-limiting aspect, the light source includes one or a series of light-emitting diodes (LEDs), one embodiment of which may include an weatherproof LED light strip or any other suitable light-emitting source. The light source may be coupled to a power source (not illustrated) by way of standard means such as electrical wiring with or without a wiring harness. In certain aspects, wiring for the light source exits the linkage through the first opening 14 and rests along the notch 34 in the end of the shaft 4. While not illustrated, the wiring may then connect to an electrical wiring harness, which is supplied with an easy connect fitting close to the main shift link housing. The harness then routes to an on/off switch and further to a fuse and then to the motorcycle battery. The power source and electrical coupling is not limited to the forgoing and may be provided as a stand-alone battery or any alternative power source readily apparent to one of skill in the art.

The light source provides backlighting to the shift linkage assembly, in particular the translucent member 22. In certain aspects, light from the light source is or may be reflected off of the interior of the shaft wall 10 (or backing) such that at least a portion of it enters the sides 28 of the first translucent member 22, when positioned in shaft 4 as discussed above. A substantial portion of the light then passes through the translucent member 22 or is reflected off of the reflective surface of back face 26 and then passes through the translucent member 22. The light may also be refracted as it passes from the translucent member 22 to the surround environment. This reflection and refraction provides a lighted appearance around the periphery of the second opening 16 and also causes the etching or engraving in the first translucent member to appear three-dimensional. As indicated above, the lighting may be white or colored light. In certain aspects, it may be programmed to provide intermittent light or to change the light color periodically over time.

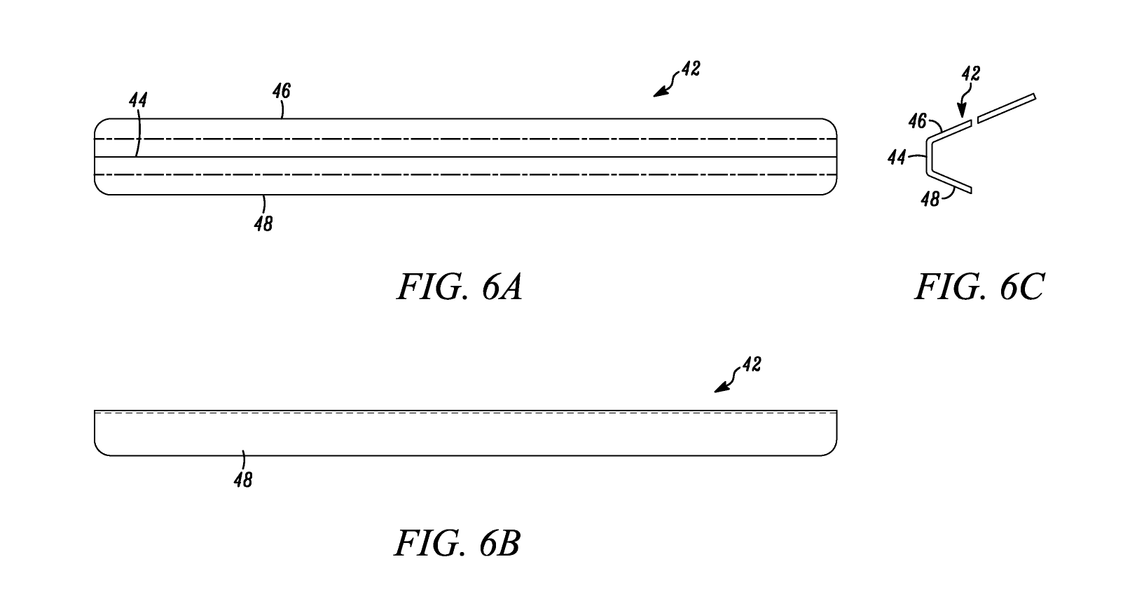

The translucent member 22 and light source may be secured within the cavity 12 of shaft 4 using a backing or rear cover 42. As illustrated in FIGS. 6A-C, in one non-limiting embodiment, this backing may be provided as a solid member and may be angled at each end to form a middle portion 44 and two side portions 46, 48. The backing may be made from any material sufficient to provide structural support in accordance with the foregoing. In certain aspects, it is comprised of a metallic-based material or a material that is or may be able to reflect light from the light source within the cavity 12 of the shaft 4. In certain aspects of the invention, the light source may be coupled to an interior side of the middle region 44 of the backing 42 using standard securing means such as an adhesive.

The backing 42 is sized to be received within the first opening 14 of the shaft 4. In certain non-limiting embodiments, and as illustrated in FIGS. 2 and 4, the interior side of the shaft wall 10 is machined to have one or more grooves 38 that are adapted to receive an end of the backing 42. In further embodiments, the shaft wall 10 contains one groove on opposing interior sides of the shaft wall 10 where each groove is adapted to receive an end of the backing 42 such that the backing is frictionally secured therewithin. The grooves 28 may be positioned proximal to the second opening 16 such that the backing ends 46, 48 are simultaneously received therewithin and also contacts the back face 26 of the first translucent member 22. In such an arrangement, the backing is secured within the shaft 4, but also secures placement of the translucent member 22 and secures the raised portion 36 of the translucent member 22 within the opening 16.

In certain non-limiting embodiments, the backing 42 is a three-sided back plate of stainless steel or aluminum having a length 7.437 inch, width 0.770 inch, height 0.460 inch, center panel width is 0.375 inch. The backing is also substantially rigid, such that it will minimize inadvertent displacement through contact or vibrations, but may provide sufficient flexibility to allow for the removal of the backing by a user. The present invention is not limited to the foregoing dimensions and materials and may also include any similar size, shape, or material that would provide a similar effect.

In accordance with the foregoing structure, the shift linkage assembly of the present invention may be secured to the shifter petal and transmission lever by way of the first and second ends 6, 8 such that the second opening 16 faces away from the motorcycle or is otherwise visible to an observer. The light source is connected to the power source and the light is turned on, providing a back light to the translucent surface 22. Again, as light passes through the translucent member, or is reflected off of its reflective surface and passes through the translucent member, it is provides a three-dimensional effect for any etching or engraving on the back face 26 of the first translucent member 22. This effect may be customized or customizable by the skilled artisan by engraving or etching a particular pattern, series of letters, numbers, symbols, or any artistic expression desired. In certain aspects, one or a series of translucent members may be provided with distinct etchings or engravings on each. These members may be interchanged or switched by the user, based on preference, by simply removing the backing 42 and light source and replacing one translucent member 22 with another.

One of skill in the art will readily appreciate that the foregoing embodiments are not necessarily limiting to the invention. Many changes, alterations, modifications and other uses and applications of the present invention will become apparent to those skilled in the art after considering the specification together with the accompanying drawings. All such changes, alterations and modifications that do not depart from the spirit and scope of the invention are deemed to be covered by the invention, which is limited only by the claims that follow.

What is claimed is:

1. A shift linker assembly for a motorcycle comprising:
a shaft comprising a first end and second end and a wall therebetween defining an interior cavity and at least one opening;
a translucent member receivable within the at least one opening of the wall comprising a translucent material having at least one reflective surface and at least one translucent surface, where the reflective surface is visible through the translucent surface and through the at least one opening; and
at least one light source disposed within the interior space of the shaft.

2. The shift linker assembly of claim 1, wherein the shaft comprises at least two openings between the first and second ends, wherein a first opening receives the translucent member such that the translucent surface and the reflective surface are visible through the second opening.

3. The shift linker assembly of claim 2, wherein the light source is disposed between the translucent member and the first opening.

4. The shift linker assembly of claim 3, further comprising a backing adapted to lockingly engage the shaft wall.

5. The shift linker assembly of claim 1, wherein the translucent member is formed to provide a lip around its periphery, wherein an interior portion of the first member extending from the lip is sized to fit within the at least one opening of the shaft and the lip has a width and length that is greater than the opening.

6. The shift linker assembly of claim 1, wherein the reflective surface of the translucent member is engravable or etchable such that an engraving or etching is visible through the translucent surface of the translucent member.

7. The shift linker assembly of claim 1, wherein the translucent member comprises acrylic material having a mirror finish on one surface forming the reflective surface.

8. A method for providing illumination to a shift linker assembly of a motorcycle comprising;
providing a shift linker assembly comprising (a) a shaft comprising a first and second end and a wall therebetween defining an interior cavity and at least one opening; (b) a translucent member receivable within at least one opening of the wall comprising a translucent surface and a reflective surface, wherein the reflective surface is visible through the translucent surface; and (c) at least one light source disposed within the interior space of the shaft;
engraving the reflective surface of the first member such that the engraving is visible through the translucent surface.
